(19) United States
(12) Patent Application Publication
(10) Pub. No.: US 2020/0097912 A1
(43) Pub. Date: Mar. 26, 2020

(54) SURFACING SELECT ELECTRONIC MESSAGES IN COMPUTING SYSTEMS

(71) Applicant: Microsoft Technology Licensing, LLC, Redmond, WA (US)

(72) Inventors: Philippe Favre, Redmond, WA (US); Huy Q. Nguyen, Bothell, WA (US); Steven Truong, Bellevue, WA (US); Zhuhao Wang, Suzhou (CN); Xucheng Zhang, Suzhou (CN); Xiaodong Wang, Suzhou (CN); Shufang Xie, Suzhou (CN); Yuwei Fang, Suzhou (CN); Jianfeng Gao, Redmond, WA (US)

(21) Appl. No.: 16/217,013

(22) Filed: Dec. 11, 2018

Related U.S. Application Data
(60) Provisional application No. 62/733,825, filed on Sep. 20, 2018.

(51) Int. Cl. G06Q 10/10; H04L 12/58

(52) U.S. Cl. CPC G06Q 10/107; H04L 51/14; H04L 51/12; H04L 51/22

(57) ABSTRACT

Techniques of selective surfacing email messages in computing systems are disclosed herein. In one embodiment, a method includes calculating an importance value corresponding to an incoming email based on one or more values of attributes of the incoming email and corresponding contribution values of the features toward the importance value. The method can then include performing a comparison between the calculated importance value of the incoming email and a preset importance threshold and, based on the performed comparison, selectively surfacing the incoming email to the user in a first section of an email inbox irrespective of a date/time of reception of the incoming email relative to other emails in the inbox.

### CROSS-REFERENCE TO RELATED APPLICATION(S)

The present application is a non-provisional of and claims priority to U.S. Provisional Application No. 62/733,825, filed Sep. 20, 2018, the disclosure of which is incorporated herein in its entirety.

### BACKGROUND

Electronic Mail (“email” or “e-mail”) is a technique of exchanging messages between users using computers, smart phones, or other suitable types of electronic devices. Email exchanges operate across computer networks such as the Internet or an intranet. Today's email systems are typically based on a store-and-forward model utilizing email servers to accept, forward, and store email messages. Users or their computers can connect to email servers or webmail interfaces via a computer network to send or receive email messages.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

To send and receive email messages, a client device can execute a standalone client application (e.g., Microsoft® Outlook), a webmail client (e.g., Gmail®) in a web browser, or other suitable types of email client to send/retrieve emails from email servers. The email client can then surface retrieved emails to a user via a user interface. The user can then read, flag, reply, delete, or perform other suitable actions on the surfaced emails via the user interface. The email client can then perform suitable operations, such as transmitting or synchronizing copies of emails with an email server, to carry out the user actions.

In certain implementations, the emails surfaced in the user interface can be arranged based on a date/time of reception, transmission, or other temporal metrics. For example, the user interface can surface the emails with the most recent emails on top of a list of received email messages in an inbox of the user. Such an arrangement, however, surfaces the most recent emails, which may not be those that require the user's immediate attention. For example, an email containing an urgent request to the user may be pushed down the list or be “diluted” by other more recently received emails containing informational broadcast.

One solution for addressing the foregoing difficulty is to filter the emails such that urgent emails are surfaced in one folder (e.g., a focus folder) while the other emails are surfaced in another folder (e.g., an inbox folder). Such a solution, however, can have certain drawbacks. For instance, some urgent emails may be miscategorized as informational and surfaced in the inbox folder while some non-urgent emails may be miscategorized as urgent and surfaced in the focus folder. Such mis-categorization of emails may cause the user skipping urgent emails and thus lose confidence in the focus folder feature and thus negatively impacting user experience of the email service.

Several embodiments of the disclosed technology can address the foregoing difficulty while providing improved user experience via the user interface for email services. Certain aspects of the disclosed technology are directed to an automatic classifier that is configured to classify emails as important or non-important based on values of various features or attributes of the emails. Example features can include a size of a body section, a number of recipients, a number of copied recipients, whether an email is replied to, forward on, etc. Each feature can have a feature value associated with an email. For example, a first email can have a size of 256K in its body section, and a value of number of recipients of one. In another example, a second email can have a size of 512K, and a value of number of recipients of twenty. Various feature values can be determined by, for example, an email scanner, by scanning the various parts of emails or via other suitable techniques. In certain embodiments, various features or attributes may be pre-defined. In other embodiments, additional and/or different features may be user defined.

In any of the foregoing embodiments, individual features can be associated with corresponding values indicating contribution of the features toward whether the email is classified as being important or non-important. In certain implementations, the contribution values can be determined via machine learning. For example, a set of emails received by a user can be manually annotated by the user as either important or non-important. In other examples, a level of importance of a received email can be inferred based on user interactions with the email in addition to or in lieu of the user's annotation. Such inference can be based on, for instance, whether the user replies/forwards to the email, a duration of reading the email by the user, an elapsed time between opening the email and replying/forwarding the email, or other suitable parameters.

A feature developer can then analyze the set of emails of the user based on the features by using a “neural network” or “artificial neural network” configured to “learn” or progressively improve performance of tasks by studying known examples. In certain implementations, a neural network can include multiple layers of objects generally refers to as “neurons” or “artificial neurons.” Each neuron can be configured to perform a function, such as a non-linear activation function, based on one or more inputs via corresponding connections. Artificial neurons and connections typically have a contribution value that adjusts as learning proceeds. The contribution value increases or decreases a strength of an input at a connection. Typically, artificial neurons are organized in layers. Different layers may perform different kinds of transformations on respective inputs. Signals typically travel from an input layer, to an output layer, possibly after traversing one or more intermediate layers. Thus, by using a neural network, the feature developer can provide a set of contribution values of the corresponding features that can be used by an automatic classifier for classifying additional received emails.

In certain embodiments, the automatic classifier can be configured to determine an importance level or probability of an incoming email based on various feature values of the email and the contribution values provided by the feature developer. For example, in one implementation, the automatic classifier can be configured to calculate an importance value of an email by summing products of feature values and contribution values of the email as follows:

Im=ΣWi×Fi

Where Iₘ is an importance value and Wi is a contribution value corresponding to a feature having a feature value Fᵢ. The importance value can include a percentage or other suitable types of representation indicating a probability that the email is an important email. In other implementations, the automatic classifier can be configured to normalize the importance values, biasing the importance values, or perform other suitable actions.

The automatic classifier can then compare the calculated importance values with a predefined threshold. In response to determining that a calculated importance value exceeds the threshold, the automatic classifier can classify the email as important by, for instance, adding and/or modifying metadata of the email related to an importance level. The added and/or modified metadata can indicate that the email is important as well as one or more reasons or “insight” why the email is deemed as important (e.g., from an important sender, regarding an important project, etc.). In certain implementations, the reasons or insights can be determined by one or more features having a value of Wi×Fi that is greater than a threshold. In other implementations, the reasons or insights can be determined as one or more features having the largest contribution to the total importance value. In further embodiments, the reason or insights can be determined in other suitable manners based on the feature values and corresponding contribution values. In yet further embodiments, the automatic classifier can also be configured to receive a user annotation of the email and provide the user annotation to the feature developer for re-evaluating the contribution values. As such, the importance levels of the emails can be determined dynamically such that emails that are deemed important for a first date/time may not be deemed important for a second date/time.

Several embodiments of the disclosed technology are also directed to surfacing unread emails to the user in a user interface based on levels of importance of the emails. In one implementation, unread emails having metadata indicating that the emails are important (referred to as “important emails” herein) can be surfaced on top of a list of emails in the user interface (e.g., an inbox) irrespective of reception/transmission date/time of the emails. For example, the important emails can be surfaced in a separate section (e.g., a “prime section”) in an inbox of the user on top of the other non-important and already read emails based on date/time of reception/transmission, corresponding importance values, or other suitable criteria. The prime section can be delineated from other sections of the inbox using a boarder, line, background, or other suitable interface elements. In another implementation, the important emails can also be surfaced in the prime section with the one or more reasons why the unread email is deemed as important. In additional implementations, when the user read, reply, forward, or otherwise interacted with a surfaced unread email in the prime section, the email can be removed from the prime section to the other sections of the inbox.

Several embodiments of the disclosed technology can thus provide the user with emails that are deemed important without having such important emails being diluted by the other non-important emails. By surfacing the important emails in a separate section of the inbox instead of another folder, the user can have ready access to these emails while user experience with the client application or webmail client can remain generally the same or even improved. In addition, by surfacing the reasons or insights why an email in the prime section is deemed important, the user can also readily ascertain additional information of the email, and thus can take suitable actions more efficiently when compared to other email surfacing techniques.

Even though the foregoing description of the disclosed technology use a binary value to indicate a relevancy value of emails, i.e., being important or non-important, in other implementations, multiple levels of relevancy may be used. For example, the automatic classifier may be configured to classify emails as most important, important, or non-important. In another example, the automatic classifier may be configured to classify emails as most important, important, somewhat important, non-important, and/or other levels of importance or relevancy. In further examples, the automatic classifier may also be configured to classify the emails in other suitable categories (e.g., most urgent, urgent, etc.) based on corresponding feature values and contribution values.

### BRIEF DESCRIPTION OF THE DRAWINGS

FIGS. 1A and 1B are schematic diagrams illustrating a computing system implementing surfacing select email messages in accordance with embodiments of the disclosed technology.

FIG. 2 is a schematic diagram illustrating certain hardware/software components of the computing system of FIG. 1 in accordance with embodiments of the disclosed technology.

FIGS. 3A and 3B are flowcharts illustrating example processes of selective email surfacing in accordance with embodiments of the disclosed technology.

FIG. 4 is a computing device suitable for certain components of the computing system in FIG. 1.

### DETAILED DESCRIPTION

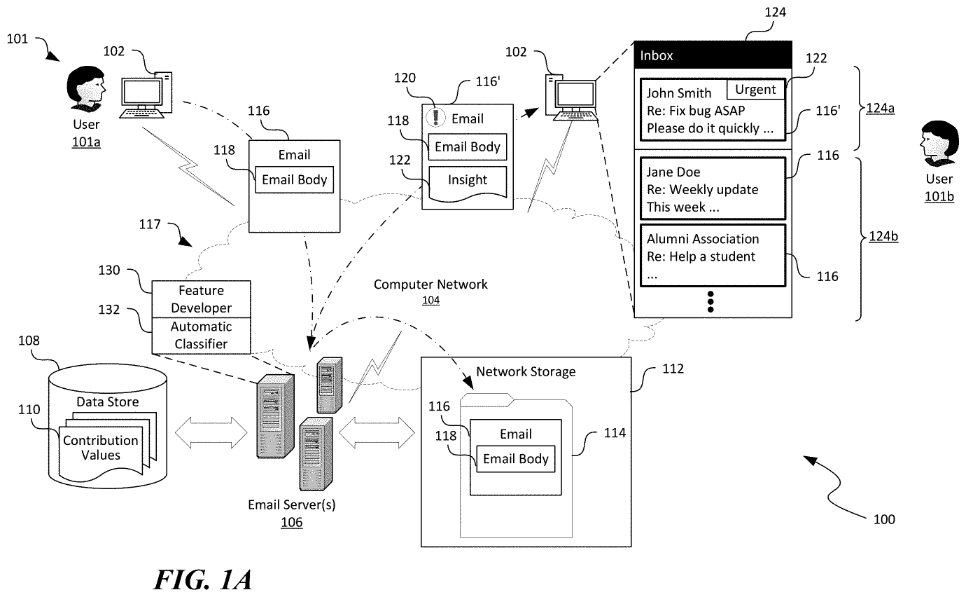

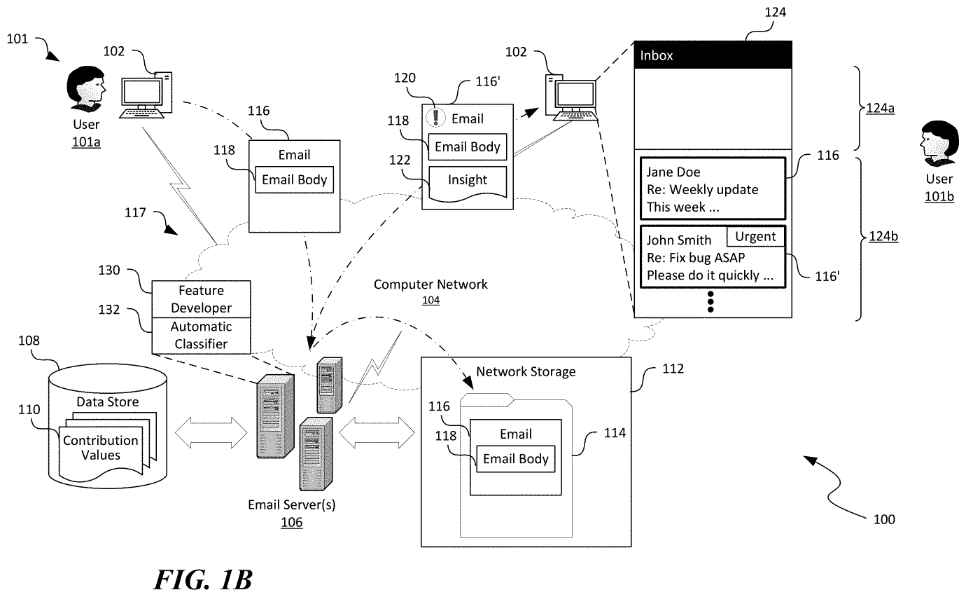

Certain embodiments of systems, devices, components, modules, routines, data structures, and processes for surfacing electronic messages in computing systems are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1A-4.

As used herein, the term “email server” generally refers to computer dedicated to running such applications that are configured to receive incoming emails from senders and forward outgoing emails to recipients via a computer network, such as the Internet. Examples of such applications include Microsoft Exchange®, qmail, Exim, and sendmail. An email server can maintain and/or access one or more inboxes for corresponding users. As used herein, an “inbox” is a file folder configured to contain data representing incoming emails for a user. The email server can also maintain and/or access one or more outboxes configured to contain outgoing emails and/or other suitable mailboxes.

Also used herein, a “feature” of an email generally refers to an attribute with a corresponding attribute or feature value of an email. Example features can include a size of a body section, a number of recipients, a number of copied recipients, whether an email is replied to, forward on, etc. Each feature can have a feature value associated with an email. For example, a first email can have a size of 256K in its body section, and a number of recipients of one. In another example, a second email can have a size of 512K, and a number of recipients of twenty. Various feature values can be determined by, for example, an email scanner, by scanning the various parts of emails or via other suitable techniques. In certain embodiments, various features or attributes may be pre-defined. In other embodiments, additional and/or different features may be user defined.

FIG. 1 is a schematic diagram illustrating a computing system 100 implementing surfacing select email messages in accordance with embodiments of the disclosed technology. As shown in FIG. 1, the computing system 100 can include a computer network 104 interconnecting client devices 102 and one or more email servers 106 (referred to as “email server 106” here in for simplicity). The email server 106 is also interconnected with a network storage 112 containing one or more inboxes 114 and a data store 108 containing contribution values 110. The computer network 104 can include an intranet, a wide area network, the Internet, or other suitable types of network. Even though particular components of the computing system 100 are shown in FIG. 1, in other embodiments, the computing system 100 can also include additional and/or different components or arrangements. For example, in certain embodiments, the computing system 100 can also include additional network storage devices, additional hosts, and/or other suitable components (not shown). In other embodiments, the network storage 112 and/or the data store 108 may be integrated into the email server 106.

The client devices 102 can each include a computing device that facilitates corresponding users 101 to access computing services provided by the email server 106 via the computer network 104. For example, in the illustrated embodiment, the client devices 102 individually include a desktop computer. In other embodiments, the client devices 102 can also include laptop computers, tablet computers, smartphones, or other suitable computing devices. Even though two users 101a and 101b are shown in FIG. 1 for illustration purposes, in other embodiments, the computing system 100 can facilitate any suitable number of users 101 to access suitable types of computing services provided by the email server 106.

The email server 106 can be configured to facilitate email reception, storage, forwarding, and other related functionalities. For example, as shown in FIG. 1, the first user 101a can utilize the client device 102 to generate and transmit an email 116 to the email server 106 either directly or via other intermediate email servers (not shown). The email 116 is destined to the second user 101b and can include an email header (not shown), an email body 118, and one or more optional attachments (not shown). Upon receiving the email 116 from the first user 101a, the email server 106 can store a copy of the email 116 in an inbox 114 on the network storage 112 that correspond to the second user 101b.

In accordance with embodiments of the disclosed technology, the email server 106 can include an automatic classifier 132 that is configured to automatically classify the incoming email 116 as being important or non-important. In certain implementations, the automatic classifier 132 can be configured to determine an importance level of an incoming email 116 based on various feature values of the email 116 and the corresponding contribution values provided by a feature developer 130. For example, in one example, the automatic classifier 132 can be configured to calculate an importance value of the email 116 by summing the product of contribution and feature values of the email 116 as follows:

Im=ΣWi×Fi

where Iₘ is an importance value and Wᵢ is a contribution value corresponding to a feature having a feature value Fᵢ. The importance value can include a percentage or other suitable types of representation indicating a probability or likelihood that the email 116 is an important email. In other implementations, the automatic classifier 132 can be configured to normalize the importance value, biasing the importance value, or perform other suitable actions.

The automatic classifier 132 can then compare the calculated importance value with a predefined threshold. In response to determining that the calculated importance value exceeds the threshold, the automatic classifier 132 can classify the email 116 as important by, for instance, adding and/or modifying metadata of the email 116 related to an importance level. The added and/or modified metadata can indicate that the email is important as well as one or more reasons or “insight” why the email is deemed as important (e.g., from an important sender, regarding an important project, etc.). In certain implementations, the reasons or insights can be determined by one or more features having a value of Wi×Fi that is greater than a threshold. In other implementations, the reasons or insights can be determined as one or more features having the largest contribution to the total importance value. In further embodiments, the reason or insights can be determined in other suitable manners based on the feature values and corresponding contribution values. For example, as shown in FIG. 1A, the automatic classifier 132 can add metadata representing a flag 120 and insight 122 to the email 116. Subsequently, the email server 106 can forward a copy of the email 116′ with the metadata representing the flag 120 and the insight 122 to the client device 102 of the second user 101b.

Upon receiving the email 116′ at the client device 102, the client device 102 can execute suitable instructions to provide an email client to provide a user interface (e.g., an inbox 124) that is configured to surface unread emails to the second user 101b based on levels of importance of the emails 116′. In one implementation, unread emails 116′ having metadata (e.g., the flag 120) indicating that the emails are important (referred to as “important emails”) can be surfaced on top of a list of emails in the user interface 124 irrespective of reception/transmission date/time of the emails 116′. For example, the important emails can be surfaced in a separate section, for instance, a “prime section” or first section 124a on top of the other non-important and/or read emails 116 in a second section 124b in an inbox of the user 101b. The first section 124a can be delineated from the second section 124b of the inbox 124 using a boarder, line, background, or other suitable interface elements. Thus, as shown in FIG. 1A, the example email 116′ in the first section 124a (e.g., an email from “John Smith”) can have a reception/transmission date/time that is earlier than one or more emails 116 in the second section 124b (e.g., emails from “Jane Doe” and “Alumni Association”).

In another implementation, the important emails 116′ can also be surfaced in the first section 124a with the one or more reasons or insights 122 why the unread email is deemed as important. For example, as shown in FIG. 1A, the email from “John Smith” is marked with a tag 122 indicating that the content of the email 116′ is urgent. In other examples, the tag 122 can also indicate that the email 116′ is from an important contact, has an actionable request, contains relevant topics, or other suitable reasons. In additional implementations, when the second user read, reply, forward, or otherwise interacted with the surfaced unread email 116′ in the first section 124a, the email 116′ can be removed from the first section 124a to the second section 124b of the inbox 124, as shown in FIG. 1B, based on date/time of reception/transmission, corresponding importance values, or other suitable criteria.

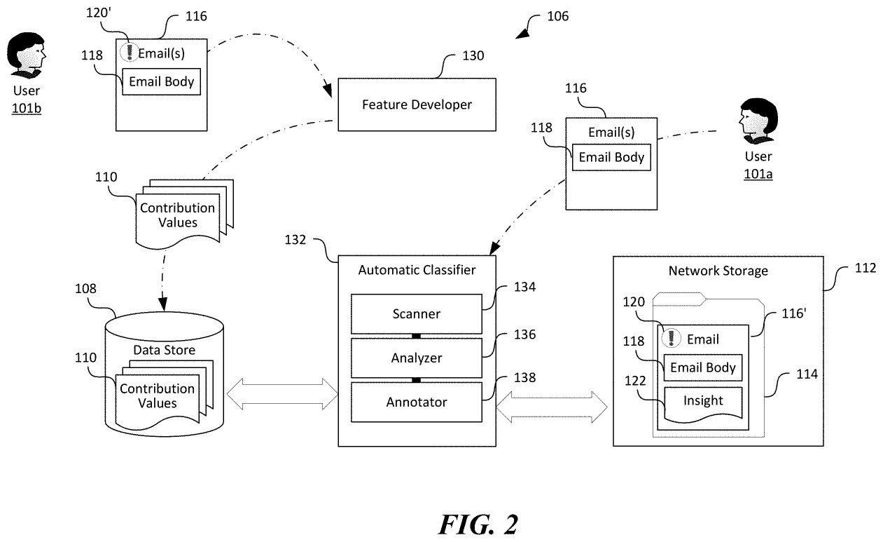

FIG. 2 is a schematic diagram illustrating certain hardware/software components of the computing system 100 in accordance with embodiments of the disclosed technology. In FIGS. 2A-2C, only certain components of the computing system 100 of FIG. 1 are shown for clarity. In FIG. 2A and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices.

Equally, components may include hardware circuitry. A person of ordinary skill in the art would recognize that hardware may be considered fossilized software, and software may be considered liquefied hardware. As just one example, software instructions in a component may be burned to a Programmable Logic Array circuit, or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 2, the email server 106 can include a feature developer 130 and an automatic classifier 132. Though the feature developer 130 and the automatic classifier 132 are shown as components of the email server 106 in FIG. 2, in other embodiments, the feature developer 130 can be provided by one or more other online or offline servers (not shown) separate from the email server 106. In further embodiments, the email server 106 can include additional and/or different components not shown in FIG. 2.

The feature developer 130 can be configured to analyze a set of emails 116 of the second user 101b based on the features by using a “neural network” or “artificial neural network” configured to “learn” or progressively improve performance of tasks by studying known examples. The set of emails 116 can be manually annotated by the second user 101b as either important or non-important, by for example, modifying a flag 120′ indicating importance. In other examples, a level of importance of the emails 116 can be inferred based on user interactions with the emails 116 in addition to or in lieu of the second user's annotation. Such inference can be based on, for instance, whether the second user 101b replies/forwards to the emails 116, a duration of reading the emails 116 by the second user 101b, an elapsed time between opening the emails 116 and replying/forwarding the emails 116, or other suitable parameters.

In certain implementations, the feature developer 130 can be configured to use a neural network that includes multiple layers of objects generally refers to as “neurons” or “artificial neurons.” Each neuron can be configured to perform a function, such as a non-linear activation function, based on one or more inputs via corresponding connections. Artificial neurons and connections typically have a contribution value that adjusts as learning proceeds. The contribution value increases or decreases a strength of an input at a connection. Typically, artificial neurons are organized in layers. Different layers may perform different kinds of transformations on respective inputs. Signals typically travel from an input layer, to an output layer, possibly after traversing one or more intermediate layers. Thus, by using a neural network, the feature developer 130 can provide a set of contribution values 110 of the corresponding features that can be used by the automatic classifier 132 for classifying additional received emails 116. In the illustrated embodiment, the feature developer 130 provides the contribution values 110 to be stored at the data store 108. In other embodiments, the feature developer 130c an provide the contribution values 110 directly to the automatic classifier 132 or store the contribution values 110 in other suitable locations.

As shown in FIG. 2, the automatic classifier 132 can include a scanner 134, an analyzer 136, and an annotator 138 operative coupled to one another. Though particular component or modules of the automatic classifier 132 are shown in FIG. 2 for illustration purposes, in other embodiments, the automatic classifier 132 can also include interface, network, or other suitable types of components and/or modules. In further embodiments, at least one of the scanners 134, analyzer 136, or annotator 138 can be provided by an external application/server separate from the automatic classifier 132.

The scanner 134 can be configured scan incoming emails 116 and determine various feature values corresponding to features with the contribution values 110. For example, the scanner 134 can be configured to determine that, a first email 116 has a size of 256K in its body section, and a number of recipient of one, and a second email 116 has a size of 512K, and a number of recipient of twenty. Upon determining the various feature values, the scanner 134 can provide the feature values to the analyzer 136 for further processing.

The analyzer 136 can be configured to determine whether an incoming email 116 is an important email or non-important email based on the feature values from the scanner 134 and the contribution values 110 from the data store 108. For example, in one example, the automatic classifier can be configured to calculate an importance value of the email 116 by summing contribution valueed feature values of the email 116 as follows:

Im=ΣWi×Fi

where Im is an importance value and Wi is a contribution value corresponding to a feature having a feature value Fi. The importance value Im can include a percentage indicating a probability that the email 116 is an important email. In other implementations, the analyzer 136 can be configured to normalize the importance value, biasing the importance value, or perform other suitable actions. The analyzer 136 can also be configured to compare the calculated importance value with a predefined threshold. In response to determining that the calculated importance value exceeds the threshold, the analyzer 136 can classify the email 116 as either important or non-important and provide the classification to the annotator 138 for further processing.

The annotator 138 can be configured to annotate the incoming emails 116 based on the classification received from the analyzer 136. For instance, the annotator 138 can be configured to add and/or modify metadata of the email 116 related to an importance level. The added and/or modified metadata can include a flag 120 that indicates that the email 116 is important as well as one or more reasons or “insight” 122 regarding why the email 116 is deemed as important (e.g., from an important sender, regarding an important project, etc.). In certain implementations, the reasons or insights can be determined by one or more features having a value of Wi×Fi that is greater than a threshold. In other implementations, the reasons or insights can be determined as one or more features having the largest contribution to the total importance value. Upon completion of the annotation, the email server 106 can then transmit a copy of the incoming emails 116 with the flag 120 and the insight 122 to the second user 101b, as described above with reference to FIGS. 1A and 1B.

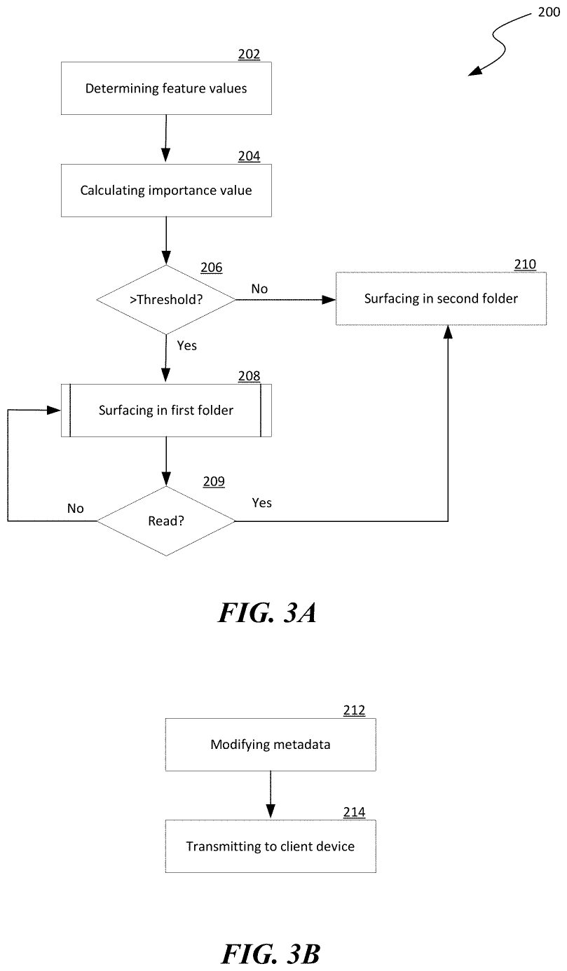

FIGS. 3A and 3B are flowcharts illustrating example processes of selective email surfacing in accordance with embodiments of the disclosed technology. Even though the processes are described below with reference to the computing system 100 of FIGS. 1A and 1B, in other embodiments, the processes can also be implemented in computing systems with additional and/or different components.

As shown in FIG. 3A, a process 200 can include determining one or more features values of an incoming email at stage 202. The features values can each correspond to a feature or attribute of the incoming email. For example, the features can individually include one of a size of a body section of the incoming email, a number of recipients of the incoming email, a number of copied recipients of the incoming email, or whether the incoming email is replied to and/or forward on.

The process 200 can also include calculating an importance value corresponding to the incoming email based on the determined feature values and corresponding contribution values of the individual features at stage 204. The contribution values can be determined via machine learning (e.g., using a neural network), adjusted by a user and/or administrator, or via other suitable techniques. In certain embodiments, the contribution values can be dynamic and thus change with respect to time. For instance, emails sent/received from another user, regarding a particular subject matter, or of other characteristics can be more or less important as time elapses. In other embodiments, the contribution values can be static at least within a date/time window.

The process 200 can then include a decision stage 206 to determine whether the calculated importance value exceeds a threshold. In response to determining that the calculated importance value exceeds the threshold, the process 200 can include surfacing the incoming email in a first folder of an inbox to a user at stage 208. Otherwise, the process 200 can include surfacing the incoming email in a second folder separate from the first folder in the inbox at stage 210. Example operations of surfacing the incoming email in the first folder are described below with reference to FIG. 3B. As shown in FIG. 3A, the process 200 can further include another decision stage 209 to determine whether the incoming email in the first folder has been read by a user. The incoming email can be deemed read when the user opens the incoming email in the email client, previews the incoming email in a preview pane, or performs other suitable actions on the incoming email. In response to determining that the incoming email has been read, the process 200 can include moving the incoming email from the first folder to the second folder and surfacing the incoming email in the second folder sorted according to a date/time of reception or other suitable parameters. Otherwise, the incoming email can be maintained in the first folder by reverting to surfacing in the first folder at stage 208.

As shown in FIG. 3B, example operations of surfacing the incoming email in the first folder can include modifying metadata of the incoming email at stage 212. In one example, modifying the metadata can include inserting, into the metadata of the incoming email, data representing an importance flag and information of one or more reasons why the incoming email is deemed as being important. In other examples, modifying the metadata can also include inserting, into the metadata of the incoming email, data representing a synchronization priority (e.g., immediate synchronization or delayed synchronization), a follow-up status, or other suitable characteristics of the incoming email. The example operations can then include transmitting the incoming email with the modified metadata to the client device to be surfaced in an email client at stage 214. In certain implementations, the client device can include a standalone email client that can surface the incoming email in the first folder according to the importance flag in the metadata of the incoming email. In other implementations, the client device can include a web-based email client that can surface the incoming email in the first folder according to the importance flag in the metadata of the incoming email.

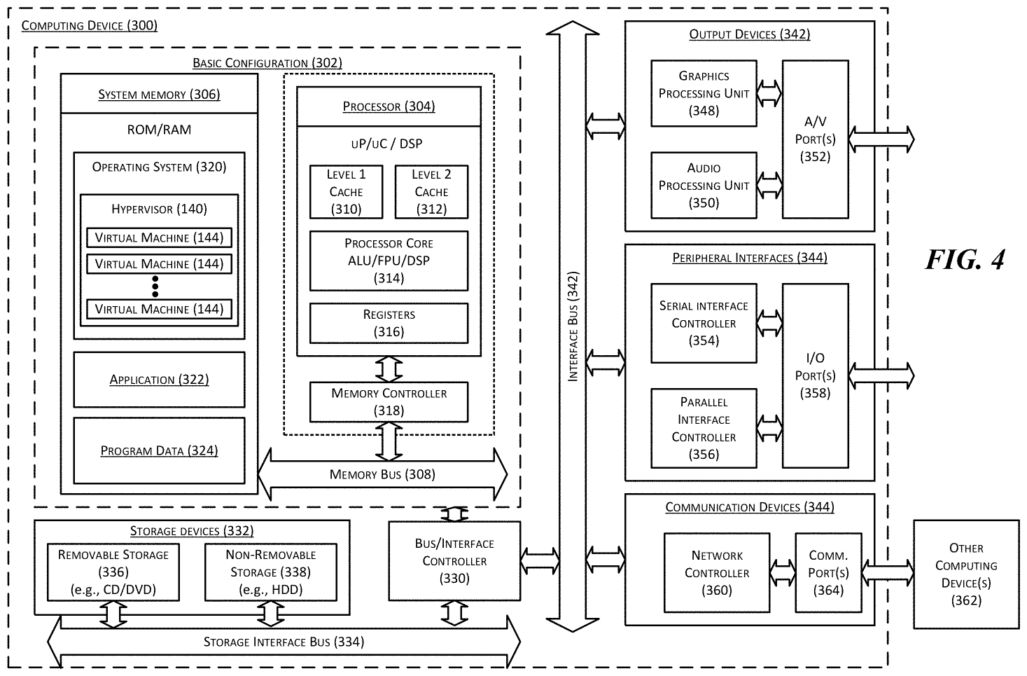

FIG. 4 is a computing device 300 suitable for certain components of the computing system 100 in FIG. 1. For example, the computing device 300 can be suitable for the email server 106 or the client devices 102 of FIG. 1. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more levels of caching, such as a level-one cache 310 and a level-two cache 312, a processor core 314, and registers 316. An example processor core 314 can include an arithmetic logic unit (ALU), a floating-point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. This described basic configuration 302 is illustrated in FIG. 3 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more A/V ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method for surfacing select incoming emails in a computing system having one or more email servers interconnected to client devices by a computer network, the method comprising:
scanning, at an email server, an incoming email to determine one or more feature values of the incoming email;
calculating an importance value corresponding to the incoming email based on the determined feature values and corresponding contribution values of the individual feature values toward the importance value of the incoming email;
determining whether the calculated importance value of the incoming email exceeds an importance threshold; and
in response to determining that the calculated importance value exceeds the importance threshold,
modifying metadata of the incoming email to include an importance flag and information of one or more reasons why the incoming email is deemed as being important; and
transmitting the incoming email with the modified metadata to a client device via the computer network to be surfaced to the user in a first section of an inbox in an email client on the client device irrespective of a date/time of reception of the incoming email, the first section being above a second section of the inbox containing additional emails.

2. The method of claim 1 wherein:
the individual feature values correspond to a feature of the incoming email; and
the features individually include one of a size of a body section of the incoming email, a number of recipients of the incoming email, a number of copied recipients of the incoming email, or whether the incoming email is replied to and/or forward on.

3. The method of claim 1 wherein:
the individual feature values correspond to features of the incoming email; and
the features are individually pre-defined or defined by a user of the incoming email.

4. The method of claim 1 wherein calculating the importance value includes summing products of feature values and contribution values of the email as follows:
Im=ΣWi×Fi
where Iₘ is an importance value and Wi is a contribution value corresponding to a feature having a feature value Fᵢ.

5. The method of claim 1 wherein modifying the metadata includes inserting metadata into data of the incoming email, the inserted metadata including the importance flag and the information of one or more reasons why the incoming email is deemed as being important.

6. The method of claim 1 wherein:
calculating the importance value includes summing products of feature values and contribution values of the email as follows:
Im=ΣWi×Fi
where Iₘ is an importance value and Wi is a contribution value corresponding to a feature having a feature value Fᵢ; and
modifying the metadata includes:
comparing a value of Wi×Fi of one of the features with a preset threshold; and
in response to determining that the value of Wi×Fi of one of the features exceeds the preset threshold, inserting, into the metadata of the incoming email, data representing the one of the features.

7. The method of claim 1 wherein:
calculating the importance value includes summing products of feature values and contribution values of the email as follows:
Im=ΣWi×Fi
where Iₘ is an importance value and Wi is a contribution value corresponding to a feature having a feature value Fᵢ; and
modifying the metadata includes:
determining one of the features of the incoming email that has a largest value of Wi×Fi amongst all of the features of the incoming email; and
inserting, into the metadata of the incoming email, data representing the one of the features that has the largest value of Wi×Fi amongst all of the features of the incoming email as the one or more reasons why the incoming email is deemed as being important.

8. The method of claim 1 wherein transmitting the incoming email includes:
transmitting the incoming email to the client device to be surfaced to the user in the first section of the inbox in the email client with one or more user interface elements representing the importance flag and the one or more reasons why the incoming email is deemed as being important.

9. The method of claim 1, further comprising:
monitoring a read status of the incoming email surfaced in the first section of the inbox on the client device; and
upon detecting that the incoming email is read by the user, removing the incoming email from the first section to the second section of the inbox.

10. A computing device configured to be interconnected to one or more client devices by a computer network, the computing system comprising:
a processor; and
a memory operatively coupled to the processor, the memory containing instructions executable by the processor to cause the computing device to:
calculate an importance value corresponding to an incoming email based on one or more feature values of corresponding features and corresponding contribution values of the features toward the importance value of the incoming email, the features individually include one of a size of a body section of the incoming email, a number of recipients of the incoming email, a number of copied recipients of the incoming email, or whether the incoming email is replied to and/or forward on;
determining whether the calculated importance value of the incoming email exceeds an importance threshold; and
in response to determining that the calculated importance value exceeds the importance threshold, surface the incoming email to the user in a first section of an inbox in an email client on a client device irrespective of a date/time of reception of the incoming email, the first section being above a second section of the inbox containing additional emails.

11. The computing device of claim 10 wherein to calculate the importance value includes to:
sum products of feature values and contribution values of the email as follows:
Im=ΣWi×Fi
where Iₘ is an importance value and Wi is a contribution value corresponding to a feature having a feature value Fᵢ.

12. The computing device of claim 10 wherein the memory contains additional instructions executable by the processor to cause the computing device to modify metadata of the incoming email to include data representing an importance flag and information of one or more reasons why the incoming email is deemed as being important.

13. The computing device of claim 10 wherein:
to calculate the importance value includes to sum products of feature values and contribution values of the email as follows:
Im=ΣWi×Fi
where Iₘ is an importance value and Wi is a contribution value corresponding to a feature having a feature value Fᵢ; and
the memory contains additional instructions executable by the processor to cause the computing device to:
comparing a value of Wi×Fi of one of the features with a preset threshold; and
in response to determining that the value of Wi×Fi of one of the features exceeds the preset threshold, insert, into metadata of the incoming email, data representing the one of the features.

14. The computing device of claim 10 wherein:
to calculate the importance value includes to sum products of feature values and contribution values of the email as follows:
Im=ΣWi×Fi
where Iₘ is an importance value and Wi is a contribution value corresponding to a feature having a feature value Fᵢ; and
the memory contains additional instructions executable by the processor to cause the computing device to:
determine one of the features of the incoming email that has a largest value of Wi×Fi amongst all of the features of the incoming email; and
insert, into metadata of the incoming email, data representing the one of the features that has the largest value of Wi×Fi amongst all of the features of the incoming email as the one or more reasons why the incoming email is deemed as being important.

15. The computing device of claim 10 wherein:
the memory contains additional instructions executable by the processor to cause the computing device to modify metadata of the incoming email to include data representing an importance flag and information of one or more reasons why the incoming email is deemed as being important; and
to surface the incoming email includes to surface the incoming email to the user in the first section of the inbox in the email client with one or more user interface elements representing the importance flag and the one or more reasons why the incoming email is deemed as being important.

16. The computing device of claim 10 wherein the memory includes additional instructions executable by the processor to cause the computing device to:
monitor a read status of the incoming email surfaced in the first section of the inbox on the client device; and
upon detecting that the incoming email is read by the user,
move the incoming email from the first section to the second section of the inbox; and
mark the incoming email as read in the second section of the inbox.

17. A method for surfacing select incoming emails in a computing system having an email servers interconnected to a client device by a computer network, the method comprising:
calculating an importance value corresponding to an incoming email based on one or more values of attributes of the incoming email and corresponding contribution values of the features toward the importance value, the attributes individually include one of a size of a body section of the incoming email, a number of recipients of the incoming email, a number of copied recipients of the incoming email, or whether the incoming email is replied to and/or forward on;
performing a comparison between the calculated importance value of the incoming email and a preset importance threshold; and
based on the performed comparison between the calculated importance value of the incoming email and the preset importance threshold, selectively surfacing the incoming email to the user in a first section of an email inbox irrespective of a date/time of reception of the incoming email relative to other emails in a second section of the inbox, the second section being delineated from the first section via an interface element.

18. The method of claim 17, further comprising upon detecting that the incoming email in the first section of the inbox has been read, moving the incoming email from the first section to the second section of the inbox and sorted according to the date/time of reception of the incoming email.

19. The method of claim 17 wherein selectively surfacing the incoming email includes surfacing the incoming email in the first section of the inbox with one or more user interface elements representing one or more reasons why the incoming email is deemed as being important.

20. The method of claim 17 wherein calculating the importance value includes:
calculating the importance value includes summing products of feature values and contribution values of the email as follows:
Im=ΣWi×Fi
where Iₘ is an importance value and Wi is a contribution value corresponding to a feature having a feature value Fᵢ.
